(19) United States
(12) Patent Application Publication
(10) Pub. No.: US 2005/0225474 A1
(43) Pub. Date: Oct. 13, 2005

(54) Aircraft antenna assembly for wireless signal reception

(75) Inventor: Alexander Steingass, Gilching (DE)

Correspondence Address: WILLIAM COLLARD;COLLARD & ROE, P.C., 1077 NORTHERN BOULEVARD, ROSLYN, NY, 11576, US

(73) Assignee: Deutsches Zentrum fur luft-und Raumfahrt e.V.

(21) Appl. No.: 11/081,391

(22) Filed: Mar. 16, 2005

(30) Foreign Application Priority Data
Mar. 17, 2004 (DE) 10 2004 013 358.1

(51) Int. Cl. H01Q 17/00

(52) U.S. Cl. 342/2; 342/4

(57) ABSTRACT

To prevent multipath reception when receiving signals, particularly satellite navigation signals, such as e.g. GPS signals, an aircraft antenna assembly including a microwave antenna (2) mounted on the skin of an aircraft fuselage (1) is covered in the surroundings of the microwave antenna with a correspondingly microwave absorbent material (3) or, as an alternative, comprises such a surface structure that the microwaves incident there are not reflected towards said microwave antenna but away therefrom. For application on aircraft antennas for satellite navigation signals, e.g. for GPS or Galileo.

The invention relates to an aircraft antenna assembly including a microwave antenna mounted on the skin of an aircraft fuselage for wireless signal reception.

In GPS signal reception it is known to mount a GPS receiving antenna on the upper side of the fuselage of an aircraft. Mounting the GPS antenna in this way may result in multipath reflections which substantially disturb reception of the GPS signal. Multipath disturbances occur when the antenna of a GPS receiver is located in the vicinity of a largish reflecting surface. Then, instead of running direct to the antenna, the satellite signal first encounters the object in the vicinity before being reflected towards the antenna, corrupting the readings.

Multipath disturbances can be reduced in this context by making use of special GPS antennas featuring an additional baseplate, usually as a round metal disk up to 50 cm in diameter which improves reception.

To maximize accuracy in GPS reception preference is given to using a choke ring antenna comprising surrounding the actual antenna, configured as a rod or vertical dipole, four or five concentric rings to reduce the indirect signal.

In the paper “The High Resolution Aeronautical Multipath Navigation Channel” by A. Steingaβ, A. Lehner, F. Pérez-Fontan, E. Kubista, M. J. Martin and B. Arbesser-Rastburg presented at the ION NTM 2004 Conference, Jan. 26-28, 2004, San Diego, Calif. USA it reads that by far the largest proportion of disturbing multipath reflections of a microwave satellite navigation signal in the case of an antenna mounted on the fuselage of an aircraft materialize directly in front of this antenna on the aircraft fuselage. However, the choke ring antennas used in many cases to eliminate multipath reflection disturbances in GPS reception, such as e.g. those of Thales Navigation or Leica, can only be put to use on an aircraft with major difficulties.

The invention is thus based on the object of providing an antenna assembly for mounting on the skin of an aircraft fuselage which substantially avoids multipath reflection when receiving microwave signals, without requiring the use of a choke ring antenna.

In accordance with the invention relating to an aircraft antenna assembly for wireless signal reception of the aforementioned kind, this object is achieved to advantage in that the fuselage skin of the aircraft is covered in the surroundings of the microwave antenna with a correspondingly microwave absorbent material or, as an alternative, comprises such a surface structure that the microwaves incident there are not reflected towards the microwave antenna but away there from.

An aircraft antenna assembly for the reception of satellite navigation signals, such as e.g. GPS signals is characterized in that the upper side of the fuselage skin is covered in the surroundings of the microwave antenna with a correspondingly microwave absorbent material or, as an alternative, comprises such a surface structure that the microwaves incident there are not reflected towards said microwave antenna but away there from.

The absorbent material or the surface structure reflecting away from the microwave antenna needs to be located surrounding the microwave antenna only within a relatively small radius, preferably within a circle of approximately one to two meters in diameter around the microwave antenna.

The correspondingly electromagnetic microwave absorbent material as provided around the microwave antenna on the fuselage skin is expediently engineered as an absorption film or absorbent surface coating, e.g. as a paint or lacquer.

Advantageous aspects of the aircraft antenna assembly in accordance with the invention read from the sub-claims relating back to the main claim directly or indirectly.

Examples of two aircraft antenna assemblies for satellite navigation signal reception in accordance with the invention will now be detailed with reference to the two FIGS. in which:

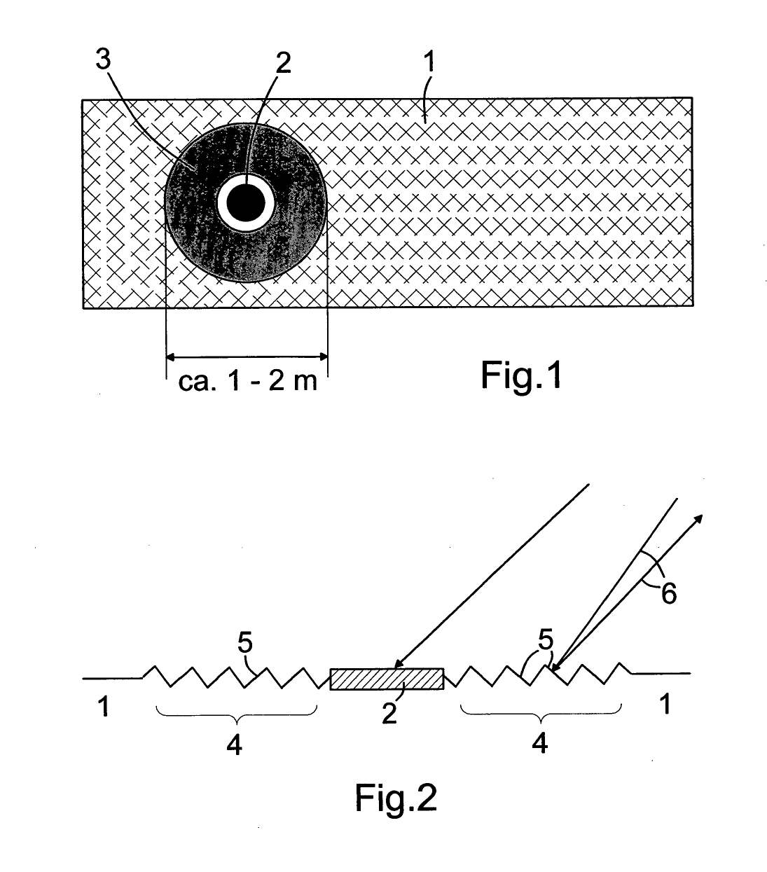

FIG. 1 is a view from above of a first example embodiment employing microwave absorbent material, and

FIG. 2 is a side section view of a second example embodiment employing a surface structure directing the incident microwaves away from the microwave antenna.

Referring now to FIG. 1 there is illustrated a view from above of the upper side of a portion of the skin of an aircraft fuselage 1 mounting a microwave antenna 2 for receiving satellite navigation signals such as e.g. GPS signals. The microwave antenna 2 tuned to receive the carrier frequency of the satellite navigation signals may be configured e.g. as a vertical rod or vertical dipole. The surface of the aircraft fuselage 1 is covered on its upper side in the surroundings of the microwave antenna 2 with a correspondingly microwave absorbent material 3. The absorbent material 3 is provided only within a relatively small radius around the microwave antenna 2, preferably within a circle of approximately one to two meters in diameter around the antenna 2.

Referring now to FIG. 2 there is illustrated in a side section view how, as an alternative to the absorbent material 3 as shown in FIG. 1, the surface of the aircraft fuselage 1 in this region features a surface structure 4 structured such that the microwaves incident there are not reflected towards the microwave antenna 2 but away therefrom. Instead of the absorbent material 3 as shown in FIG. 1 sawtooth-shaped deflector grooves 5 are provided in this region concentrically surrounding the microwave antenna 2 as shown in FIG. 2 which direct the incident satellite navigation signal microwaves 6 away from the microwave antenna 2. The concentric sawtooth-shaped deflector grooves 5 of the surface structure 4 can be filled to advantage with a plastics material to maintain the smooth streamline finish of the fuselage skin surface.

### List of Reference Numerals

1 aircraft fuselage
2 microwave antenna
3 absorbent material
4 surface structure
5 sawtooth-shaped deflector grooves
6 microwaves

1. An aircraft antenna assembly including a microwave antenna mounted on the skin of an aircraft fuselage for wireless signal reception, characterized in that the skin of said aircraft fuselage (1) is covered in the surroundings of said microwave antenna (2) with a correspondingly microwave absorbent material (3) or, as an alternative, comprises such a surface structure (4) that the microwaves (6) incident there are not reflected towards said microwave antenna but away therefrom.

2. The aircraft antenna assembly as set forth in claim 1, characterized in that for the reception of satellite navigation signals, such as e.g. GPS signals the upper side of the skin of said fuselage (1) is covered in the surroundings of said microwave antenna (2) with a correspondingly microwave absorbent material (3) or, as an alternative, comprises such a surface structure (4) that the microwaves (6) incident there are not reflected towards said microwave antenna but away therefrom.

3. The aircraft antenna assembly as set forth in claim 1, characterized in that said absorbent material (3) or said surface structure (4) reflecting away from said microwave antenna is provided within a circle of approximately one to two meters in diameter around said microwave antenna (2).

4. The aircraft antenna assembly as set forth in claim 2, characterized in that said absorbent material (3) or said surface structure (4) reflecting away from said microwave antenna is provided within a circle of approximately one to two meters in diameter around said microwave antenna (2).

5. The aircraft antenna assembly as set forth in claim 1, characterized in that said absorbent material (3) is an absorption film.

6. The aircraft antenna assembly as set forth in claim 2, characterized in that said absorbent material (3) is an absorption film.

7. The aircraft antenna assembly as set forth in claim 3, characterized in that said absorbent material (3) is an absorption film.

8. The aircraft antenna assembly as set forth in claim 4, characterized in that said absorbent material (3) is an absorption film.

9. The aircraft antenna assembly as set forth in claim 1, characterized in that said absorbent material (3) is an absorbent surface coating.

10. The aircraft antenna assembly as set forth in claim 2, characterized in that said absorbent material (3) is an absorbent surface coating.

11. The aircraft antenna assembly as set forth in claim 3, characterized in that said absorbent material (3) is an absorbent surface coating.

12. The aircraft antenna assembly as set forth in claim 4, characterized in that said absorbent material (3) is an absorbent surface coating.

13. The aircraft antenna assembly as set forth in claim 9, characterized in that said absorbent surface coating is an absorbent lacquer.

14. The aircraft antenna assembly as set forth in claim 10, characterized in that said absorbent surface coating is an absorbent lacquer.

15. The aircraft antenna assembly as set forth in claim 11, characterized in that said absorbent surface coating is an absorbent lacquer.

16. The aircraft antenna assembly as set forth in claim 12, characterized in that said absorbent surface coating is an absorbent lacquer.

17. The aircraft antenna assembly as set forth in claim 9, characterized in that said absorbent surface coating is an absorbent paint.

18. The aircraft antenna assembly as set forth in claim 10, characterized in that said absorbent surface coating is an absorbent paint.

19. The aircraft antenna assembly as set forth in claim 11, characterized in that said absorbent surface coating is an absorbent paint.

20. The aircraft antenna assembly as set forth in claim 12, characterized in that said absorbent surface coating is an absorbent paint.

21. The aircraft antenna assembly as set forth claim 1, characterized in that sawtooth-shaped deflector grooves (5) are provided concentrically surrounding said microwave antenna (2) which direct the incident satellite navigation signal microwaves 6 away from said antenna.

22. The aircraft antenna assembly as set forth claim 2, characterized in that sawtooth-shaped deflector grooves (5) are provided concentrically surrounding said microwave antenna (2) which direct the incident satellite navigation signal microwaves 6 away from said antenna.

23. The aircraft antenna assembly as set forth claim 3, characterized in that sawtooth-shaped deflector grooves (5) are provided concentrically surrounding said microwave antenna (2) which direct the incident satellite navigation signal microwaves 6 away from said antenna.

24. The aircraft antenna assembly as set forth in claim 21, characterized in that said concentric sawtooth-shaped deflector grooves (5) of said surface structure 4 are filled with a plastics material so that a smooth streamline finish of the skin of said fuselage (1) materializes.

25. The aircraft antenna assembly as set forth in claim 22, characterized in that said concentric sawtooth-shaped deflector grooves (5) of said surface structure 4 are filled with a plastics material so that a smooth streamline finish of the skin of said fuselage (1) materializes.

26. The aircraft antenna assembly as set forth in claim 23, characterized in that said concentric sawtooth-shaped deflector grooves (5) of said surface structure 4 are filled with a plastics material so that a smooth streamline finish of the skin of said fuselage (1) materializes.
